(19) United States
(12) Patent Application Publication
(10) Pub. No.: US 2012/0281446 A1
(43) Pub. Date: Nov. 8, 2012

(54) PREVENTING LOAD DUMP OVERVOLTAGES IN SYNCHRONOUS RECTIFIERS,

(76) Inventors: Fabio Magini, Hemmingen (DE); Paul Mehringer, Stuttgart (DE); Alexander Shendi, Asperg (DE); Andeas Windmueller, Asperg (DE); Ralf Herbig, Leonberg (DE)

(21) Appl. No.: 13/510,761

(22) PCT Filed: Nov. 17, 2010
(86) PCT No.: PCT/EP10/67614

§ 371 Date: Jul. 26, 2012

(30) Foreign Application Priority Data
Nov. 23, 2009 (DE) 10 2009 046 955.9

(51) Int. Cl. H02M 7/06

(52) U.S. Cl. 363/64

(57) ABSTRACT

In a method for reducing load dump overvoltages during operation of a synchronous rectifier for a polyphase alternating current having a number of inputs which correspond to the number of alternating current phases of the alternating current, and having at least two outputs for providing a direct current, an alternating current phase is connected to each of the inputs, and each of the inputs are electrically optionally connected via active switching elements to either the first or the second output in accordance with a control unit.

### BACKGROUND OF THE INVENTION

1. Field of the Invention

The present invention relates to a device and a method for preventing load dump overvoltages during operation of a synchronous rectifier for a polyphase alternating current.

2. Description of Related Art

It is known to use rectifiers for supplying direct current systems from three-phase current sources, e.g., the public three-phase system. The rectifiers are usually constructed as a bridge circuit, diodes being used as rectifier elements in the simplest case. These diodes do not require any additional control circuit since they automatically change to the conductive or blocking state at the right point in time, i.e., when the voltage threshold values are exceeded or are not reached.

Six-pulse bridge rectifiers (in three-phase currents) are also used as rectifiers in three-phase current generators of motor vehicles (electric generators). Generators of this type have a pronounced inductive internal resistance.

A bridge rectifier has power losses defined by the diodes and the output current. These losses may be reduced only insignificantly by circuitry-related measures, such as parallel switching of diodes.

For efficiency reasons, it is, however, desirable to reduce these losses. For this purpose, the diodes may be replaced by active switches (for example, MOSFET transistors). As will be discussed in the following, additional protective functions or strategies are, however, to be provided in this case.

The load dump is always a critical case of error when designing an active rectifier. It occurs if, in the case of an accordingly highly excited machine and an accordingly great portion of output current, the load at the generator is suddenly reduced (for example, by switching off the consumers), and this sudden reduction cannot be compensated for by capacitively acting elements in the vehicle electrical system (e.g., the battery).

In extreme cases, it is possible for the generator to continue its energy supply into the vehicle electrical system up to a duration of approximately 300 ms to 500 ms. It must be possible to then convert (“remove”) this energy in the rectifier in order to protect electrical components which are connected to the generator against overvoltage damage. In conventional rectifiers, this protection is usually achieved by designing the rectifier diode as a power Zener diode.

In conventional diode rectifiers, the energy loss may thus be effectively converted into heat. The diodes offer an adequate assembly and joining technique in the form of an extensive thermal connection. In the MOSFETs presently available, these properties may, however, not be recreated to 100%. Therefore, other measures must be taken to compensate for the power losses.

To remove the load dump energy, it is proposed in published European patent EP 0 777 309 B1 that some or all plus or minus diodes (i.e., the diodes which are associated with the plus pole or the minus pole of the rectifier, in the following also referred to a diodes of the upper or the lower rectifier arms) are short-circuited entirely or temporarily. In the method proposed therein, the control signal of the bridge elements is clocked so that the voltage does not fall below a minimum level and a maximum voltage level is not exceeded. However, such repeated clocking of a control signal within one half-wave (i.e., at a higher frequency than the applied alternating current phase in each case) has a series of disadvantages. Apart from the formation of parasitic voltage peaks (having negative effects on the electromagnetic compatibility), high power losses are temporarily generated in the electrical switches, in particular during corresponding switching-off operations. Even if the activation frequency of the limiting circuit is selected to be too low, there is the risk of parasitic voltage peaks being output into the sensitive vehicle electrical system. Control circuits having a fast response rate usually also have an increased susceptibility to errors; in addition, a corresponding device requires an analyzer circuit for each phase to detect corresponding current values.

Published European patent application EP 1 443 623 A2 discloses a system and a method for controlling load dump voltages of a synchronous machine. Here, a control unit generates control signals for the switching elements of the upper or the lower rectifier arm. If the phase voltage applied to a switching element exceeds a threshold value, it is switched to be conductive. For this purpose, a voltage analysis is also necessary for each individual phase.

It is thus desirable to suppress load dump overvoltages in synchronous rectifiers for polyphase alternating currents in a cost-effective and reliable manner.

### BRIEF SUMMARY OF THE INVENTION

The present invention relates to a synchronous rectifier which recreates the “zenering” of a conventional bridge rectifier with the aid of external activation; MOSFETs, for example, are used as switching elements. In accordance with a control, these switching elements allow a connection of each input of the rectifier, to which one phase of the polyphase alternating current is applied in each case, to either the plus pole or the minus pole of the rectifier. The minus pole output may be grounded or be connected to ground, whereby the rectifier is also grounded when one of its inputs is connected to the minus pole output.

In contrast to the previously mentioned related art, only a corresponding load dump recognition between the battery poles (B+ and B−) is necessary in the present invention due to the use of a time-controlled method in which the load dump does not have to be recognized in each individual phase. For the voltage analysis of each individual phase, a simple comparison is sufficient, for example. A determination of a load dump situation and a subsequent introduction of the measures according to the present invention are thus executable very easily and reliably. The actual energy-reducing measures within the load dump (i.e., within the time period during which an energy reduction is necessary) may be carried out as soon as a load dump situation has been recognized on the basis of pure time control with the aid of an instantaneous rotational speed, for example, which correlates with the time period of the phases of a generated three-phase current. An overvoltage recognition in each individual phase, as is necessary in the related art mentioned above, is not necessary, however. With regard to the electromagnetic compatibility, no disadvantages are to be expected since the activation frequency is reduced due to the proposed approach and is not increased as is the case in the related art.

It is particularly advantageously possible to achieve an adapted reduction of the load dump energy with the aid of the two proposed alternatives of the approach according to the present invention, according to which exactly one input of the rectifier is connected in each case to the second output (i.e., the minus pole output) during the time period of applying an entirely positive half-wave of an alternating current phase connected to this input and, simultaneously or alternatively, exactly one input is connected in each case to the first output (i.e., the plus pole output) during the time period of applying an entirely negative half-wave of an alternating current phase connected to this input.

In other words, this is achieved by either the diodes of only one of the rectifier arms being bridged or short-circuited, or else both arms being simultaneously interfered with. A step-by-step relief results in accordance with these alternatives.

Within the scope of the present invention, individual phases of the rectifier are thus temporarily short-circuited during a load dump. It is to be pointed out that no high-frequency clocking of the activation of the corresponding switching elements must be carried out for this purpose, but rather that the clocking pattern must be modified in such a way that individual switching elements remain switched on for a longer period of time (for example, by factor 3). In this way, the voltage supply by a corresponding generator rectifier continues to be ensured and a simple activation is possible with little effort. The power output of the generator is, however, considerably reduced since the arising power loss, which results in the particular “zenering” arm, is temporarily short-circuited. For this reason, a part of the additional power loss must be converted into heat in the (robust and thus suitable) generator, since fewer power losses may be converted into heat in the rectifier. The measures according to the present invention may be particularly advantageously used in five-phase systems; in principle, the method described above is also implementable in systems having a different number of phases, in particular systems having 3+n phases, with n=0, 1, 2 . . . .

### BRIEF DESCRIPTION OF THE DRAWINGS

FIG. 1 shows a longitudinal section through an alternating current generator for motor vehicles according to the related art.

FIG. 2 shows a wiring diagram of a generator for a five-phase alternating current having a bridge rectifier according to the related art.

FIG. 3 shows a simplified wiring diagram of a generator for a five-phase alternating current having a bridge rectifier according to the related art with the indication of the current flow.

FIG. 4 shows an activation diagram for switching elements of a bridge rectifier during normal rectifier operation according to the related art.

FIG. 5 shows another activation diagram for switching elements of a bridge rectifier during normal rectifier operation according to the related art.

FIG. 6 shows a simplified wiring diagram of a generator for a five-phase alternating current having a bridge rectifier according to the related art, indicating the current flow in a load dump situation.

FIG. 7 shows an activation diagram for switching elements of a bridge rectifier in a load dump situation according to particularly advantageous specific embodiments of the present invention.

FIG. 8 shows another activation diagram for switching elements of a bridge rectifier in a load dump situation according to one particularly advantageous specific embodiment of the present invention.

FIG. 9 shows power losses of switching elements of a bridge rectifier in a load dump situation when using a method according to the related art.

FIG. 10 shows power losses of switching elements of a bridge rectifier in a load dump situation when using a method according to the diagram represented in FIG. 7A.

FIG. 11 shows power losses of the switching elements of a bridge rectifier in a load dump situation when using a method according to the diagram represented in FIG. 8.

FIG. 12 shows temperature and current characteristics curves in switching elements of a bridge rectifier for a three-phase current in a load dump situation according to the related art and when using a method according to the diagram represented in FIG. 7B.

### DETAILED DESCRIPTION OF THE INVENTION

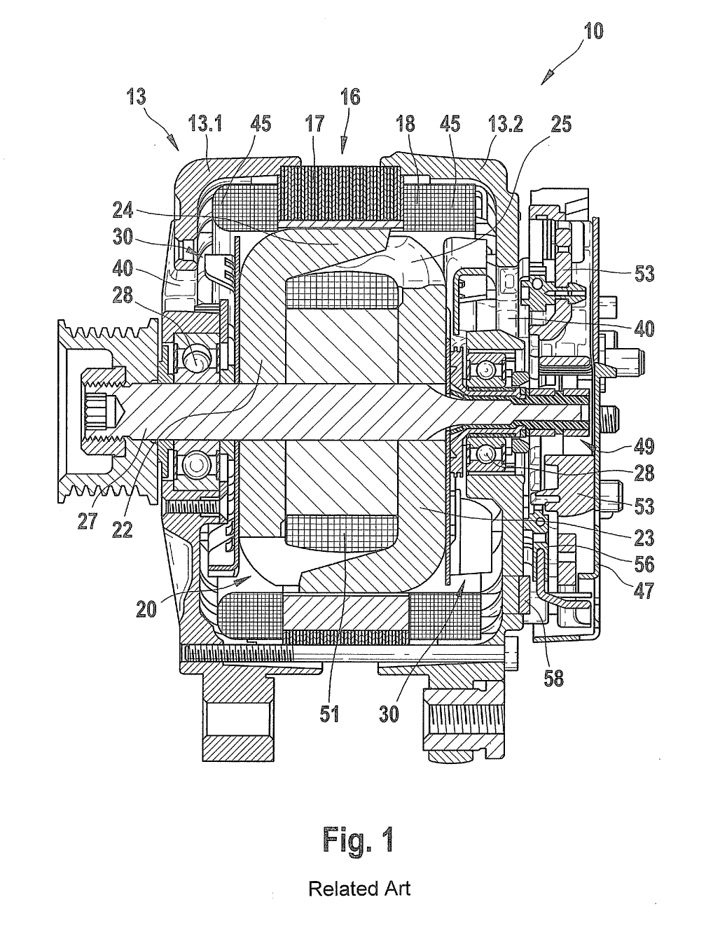

FIG. 1 shows a section through an alternating current generator 10 for motor vehicles according to the related art in which the method according to the present invention may be implemented.

The generator has a two-part housing 13 including a first end bracket 13.1 and a second end bracket 13.2. End bracket 13.1 and end bracket 13.2 accommodate a stator 16 having an annular lamination stack 17 into which a stator winding 18 is introduced. Stator 16 surrounds a rotor 20 with its radially internally oriented surface.

Rotor 20 has two claw-pole circuit boards 22 and 23 having claw-pole fingers 24 and 25 on their respective peripheries.

Both claw-pole circuit boards 22 and 23 are situated in such a way that their respective claw-pole fingers 24 and 25 alternate as north and south poles at the circumference of rotor 20.

Rotor 20 is rotatably mounted in particular end brackets 13.1 and 13.2 with the aid of a shaft 27 and each of rolling-contact bearings 28 located on each of the rotor sides. It has two axial front surfaces, a fan 30 being fastened to each of them.

Fan 30 is used to enable an air exchange with the interior of electric machine 10 via openings 40 in end brackets 13.1 and 13.2. For this purpose, cooling air is accelerated radially to the outside by the rotation of fan 30 so that it may pass through winding heads 45 on the drive side and 46 on the electronics side, which are permeable to the cooling air.

A protective cap 47 protects various components such as a collector ring assembly 49, which supplies a field winding 51 with field current, against environmental influences. A cooling body 53, which functions as a pulsed cooling body and on which pulsed diodes are installed, is situated around collector ring assembly 49. Between end bracket 13.2 and cooling body 53, a connecting plate 56 is situated which connects minus diodes 58 fastened to end bracket 13.2 and pulse diodes (not shown) in the cooling body in the form of a bridge circuit 29.

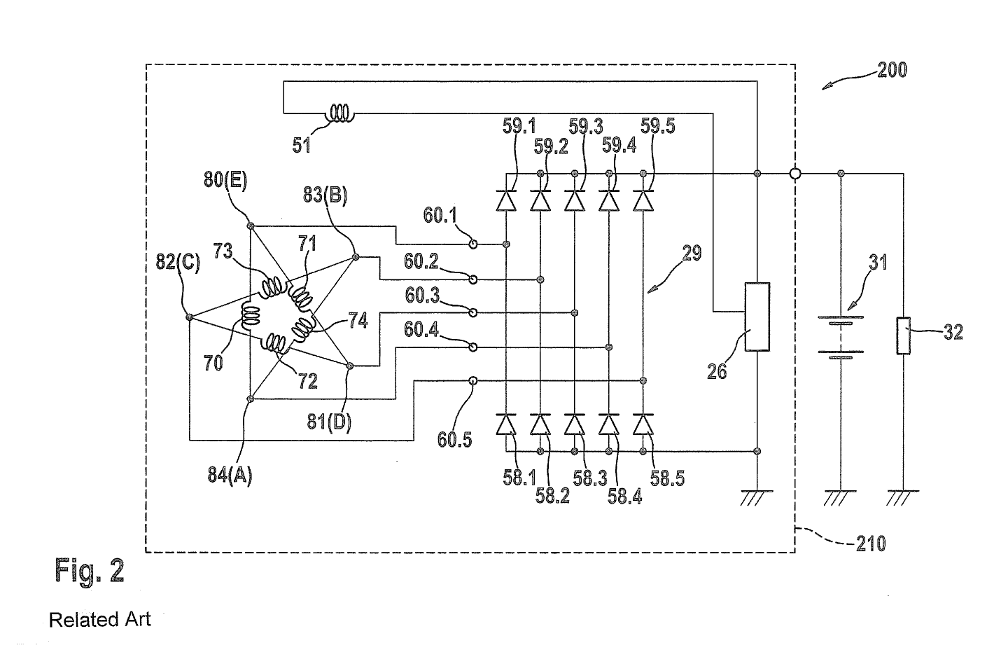

FIG. 2 shows an alternating current generator 200 according to the related art having five phase-building winding phases 70 through 74 on the basis of a wiring diagram.

Stator winding 18 (see FIG. 1) forms the total of all winding phases 70 through 74. The five phase-building winding phases 70 through 74 are interconnected to form a basic circuit in the form of a five-point star (pentagram), each of the phases interconnected at the points of the star being at an angle of approximately 36°. A rectifier bridge circuit 29 is connected at interconnecting points 80 through 84 of the points of the five-point star. During operation of the generator, the five phases A through E of a five-phase alternating current are output via interconnecting points 80 through 84. The winding phases are interconnected as follows:

Winding phase 70 is connected to winding phase 71 at interconnecting point 80. At its opposite end, winding phase 71 is connected to winding phase 72 at interconnecting point 81. At its opposite end, winding phase 72 is connected to winding phase 73 at interconnecting point 82. At its opposite end, winding phase 73 is connected to winding phase 74 at interconnecting point 83. At its opposite end, winding phase 74 is connected to winding phase 70 at interconnecting point 84. The interconnecting points are preferably located axially next to winding head 45 on the electronics-side to implement short interconnection distances.

Interconnecting points 80 through 84 of winding phases 70 through 74 are connected via inputs 60.1 through 60.5 to separate bridge rectifier 29 which is constructed from five minus diodes 58.1 through 58.5 and five plus diodes 59.1 through 59.5. On the direct voltage side, a voltage controller 26 is switched in parallel, which controls the voltage of the generator by influencing the current flowing through field coil 51. Voltage controller 26 may additionally have a connection to rectifier 29 to measure the voltage drop over a diode, to ascertain the instantaneous rotational speed of the generator therefrom and to generate a clock signal therefrom. The vehicle electrical system is schematically illustrated through vehicle battery 31 and vehicle consumers 32. The rectifier and the associated generator are situated in a housing 210.

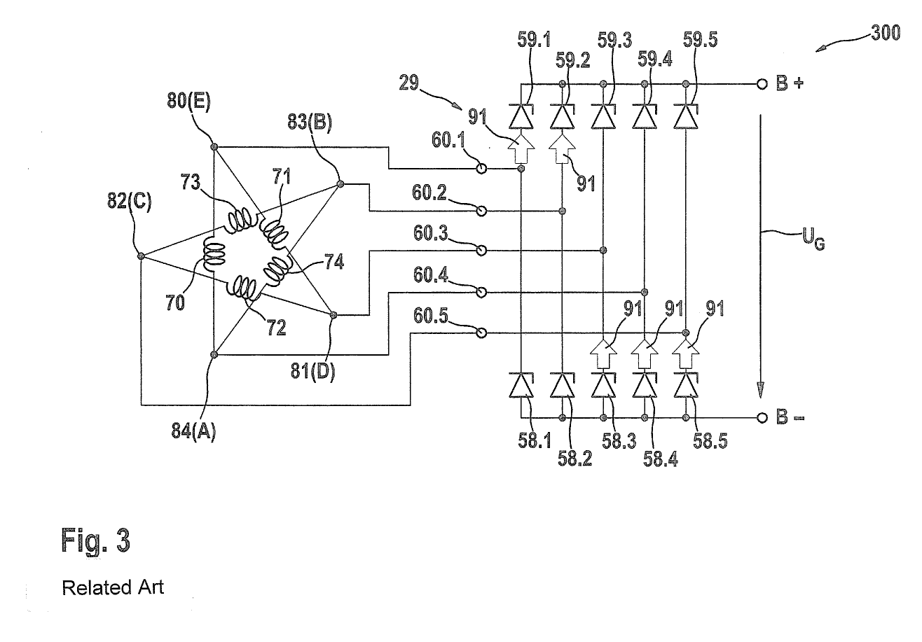

FIG. 3 shows a system 300 having a five-phase generator and a Zener diode rectifier according to the related art. It must be understood that a rectifier of this type may have, instead of the illustrated diodes, active switching elements such as MOSFETs or IGBTs with the aid of which each of rectifier inputs 60.1 through 60.5 may optionally be connected to a first B+ or a second B− output (or conducted to it). A corresponding interconnection may, however, be plotted satisfactorily with the aid of the diodes of FIG. 3. The representation is simplified as compared to FIG. 2. In particular, where battery 31 was previously illustrated, only two battery poles B+ and B− are illustrated between which a generator voltage U_{G} is applied. A representation of field winding 51 and vehicle electrical system consumer 32 has been dispensed with.

In circuit 300, the current directions are additionally indicated with arrows 91. During normal rectifier operation, either two plus diodes (e.g., 59.1, 59.2) and three minus diodes (e.g., 58.3 through 58.5) or (not shown in the Figure) three of plus diodes 59.1 through 59.5 and two of minus diodes 58.1 through 58.5 are always in the conductive, i.e., low-resistance, state. The particular conductive diodes alternate cyclically.

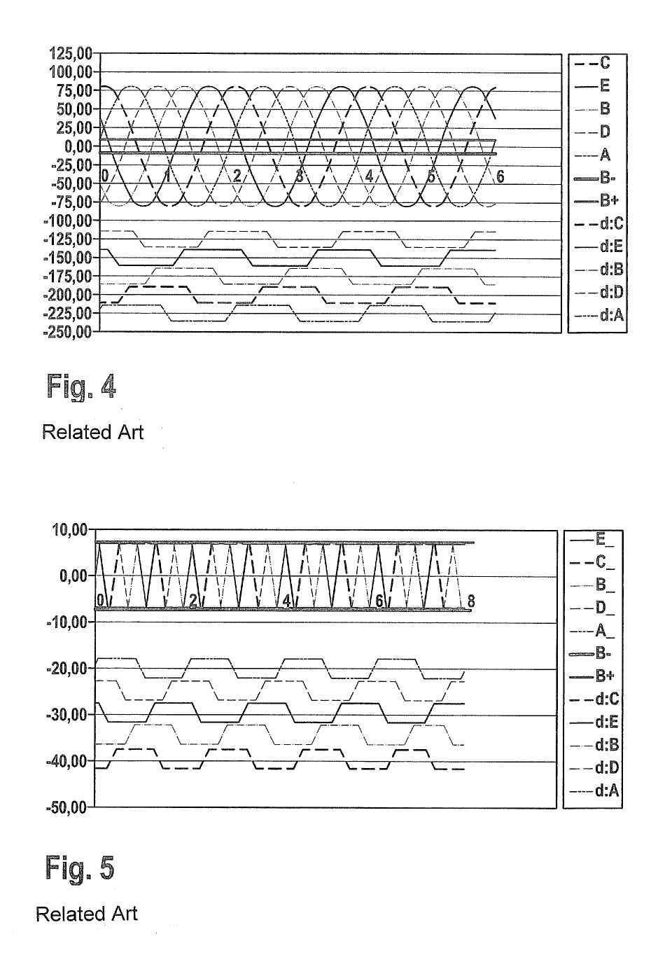

In FIG. 4, an activation sequence of an active rectifier is illustrated during normal operation (i.e., outside of a load dump situation) in the form of voltage characteristics curves plotted against time. The voltage signals resulting therefrom at outputs B+ and B− are also indicated.

For the phase voltages, the presumed free idle voltages A through E are plotted which correspond to the phases output via interconnecting points 80 through 84 of a corresponding generator. Furthermore, the switching states of the switching elements are illustrated and are identified with d:A through d:E. The lower value in the characteristics curves d:A through d:E means in each case that the associated MOSFET is conducted to B−; the high value means that the corresponding MOSFET is conducted to B+. During real rectifier operation, the potential of the phases is forced in each case to B+ plus the diode flow voltage or to B− minus the diode flow voltage due to the short-circuit of the conductive diodes.

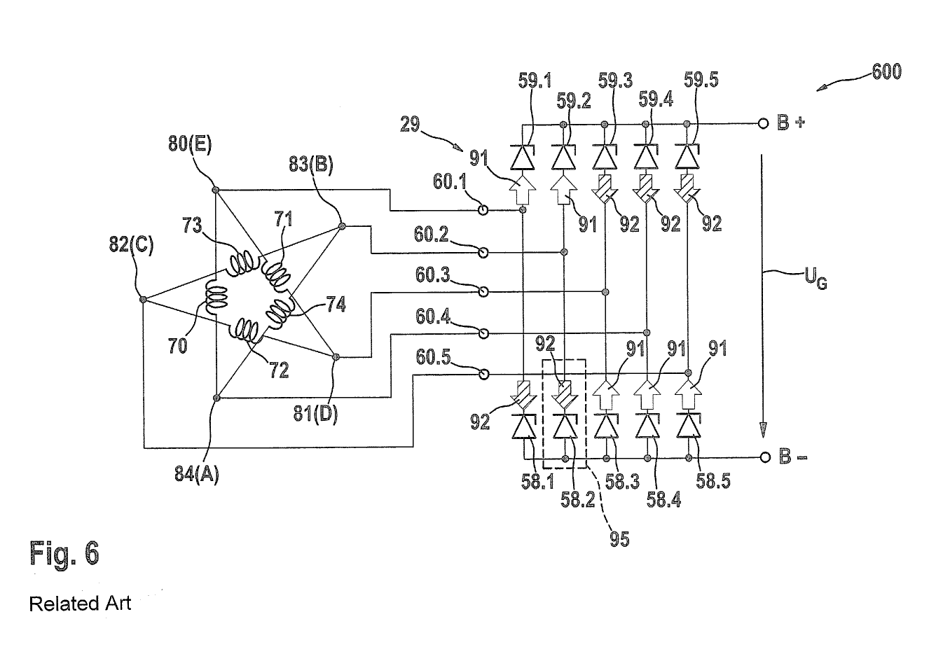

A corresponding activation sequence is illustrated in FIG. 5. The activation sequence shows the characteristics curve of phase voltages A_{—} through E_{—} which correspond, as previously explained, to phase voltages A through E during real rectifier operation.

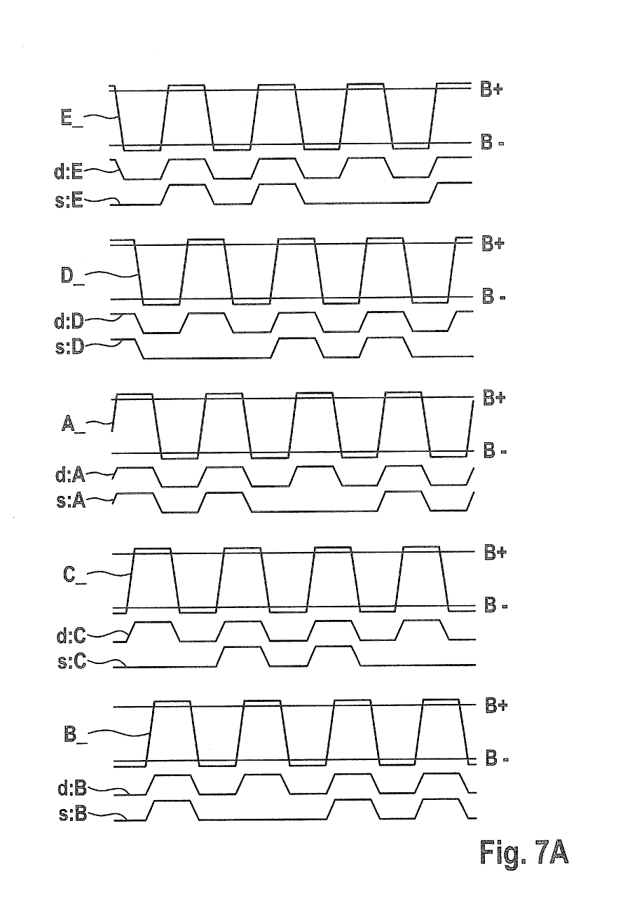

FIG. 6 shows a snapshot of the current distribution in a circuit 600, which corresponds to circuit 300 of FIG. 3, in the case of a load dump. As in FIG. 3, not shaded arrows 91 identify a current into the diode flow direction; additionally, a current into the Zener direction is indicated by shaded arrows 92. Currents 92 into the Zener direction are critical in particular because a higher power loss (U×I) is generated by the reverse currents due to the higher voltage.

According to a particularly preferred specific embodiment of the present invention, it is now provided that switches are continuously, i.e., cyclically, short-circuited in this Zener direction for the time period of an entire half-wave. During this type of short-circuit, a significantly reduced energy loss is in effect. In this way, a thermal relief is created for a certain period of time, while the vehicle electrical system continues to be supplied during this period of time.

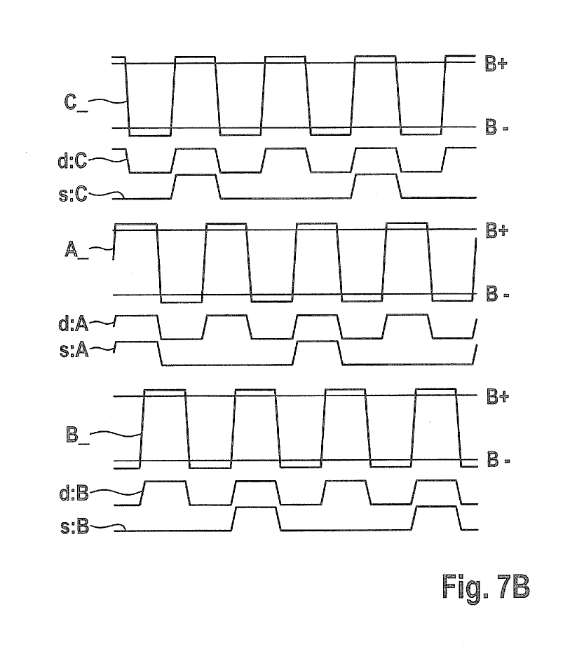

FIG. 7 shows possible activation sequences according to particularly preferred specific embodiments of the present invention. FIG. 7A shows an activation diagram for a five-phase current; an analog diagram for a three-phase current is indicated in FIG. 7B. The characteristics curves A_through E_or A_through C_, d:A through d:E or d:A through D:C as well as B+ and B− initially correspond to those in FIG. 5.

The method for the characteristics curve of FIG. 7A may be explained as follows. The activation sequence results during operation using a five-phase generator. The high level in characteristics curve d:B corresponds to an activation of the switch toward B+ (symbolized by diode 59.2 in FIG. 6). The opposite arm toward B− (identified as 95 in FIG. 6) is in “zenering” condition (diode 58.2 in FIG. 6) at this point in time. Now, if the switch between interconnecting point 83 and battery pole B− is actively closed (short-circuited) at this point in time, the potential of interconnecting point 83 is forced to ground. Thus, the otherwise high power loss due to the conversion of the Zener voltage does not occur. Furthermore, the current portion which would flow toward B+ is deflected to B−. This diagram may now be cyclically used for the other switches, as shown in FIG. 7A. According to this specific embodiment, s:A through s:E indicate the characteristics curves according to the present invention, in FIG. 7A; i.e., this corresponds to an activation diagram for reducing the power loss during the load dump in the lower arm of the bridge rectifier. Exactly one positive half-wave is conducted to pole B− at each point in time.

In the diagram of FIG. 7B, which in principal corresponds to FIG. 7A, no more than one positive half-wave is conducted to B− at each point in time. The activation sequence results during operation using a three-phase generator. Here, too, the particular switches of an arm are cyclically short-circuited (here alternating).

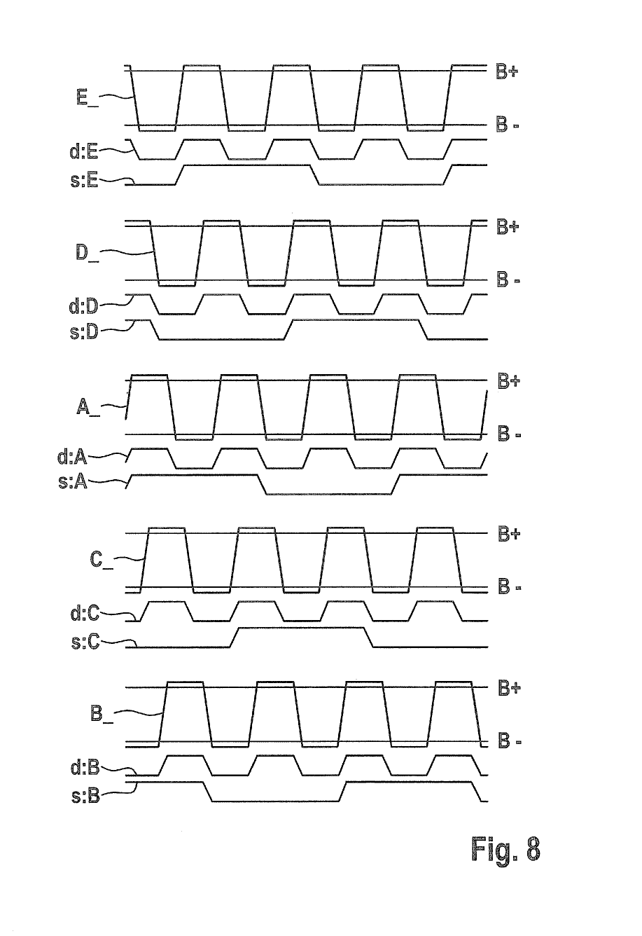

By using the same principle in the upper arm of the rectifier bridge, another relief results in this arm. The associated activation diagram for a five-phase current is shown in FIG. 8 and is identified as in FIG. 7A. In FIG. 8, a regular activation diagram results having activation times which are extended by a factor 3 as compared to the normal operation.

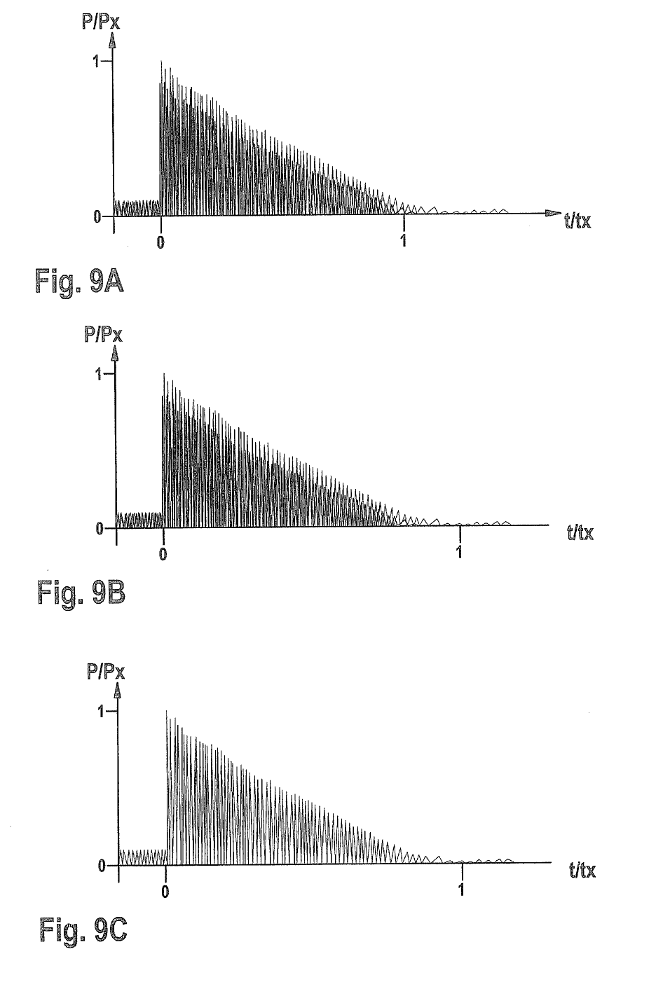

The measures according to the present invention were checked for their effectiveness within the scope of a simulation, as shown in FIGS. 9 through 11. A complete load dump (100% load dump) was simulated on a five-phase generator. The field coil was in a completely excited state prior to the simulated load dump event, and the generator was in an oscillated state. The short-circuiting of the switching elements was carried out by controlled elements.

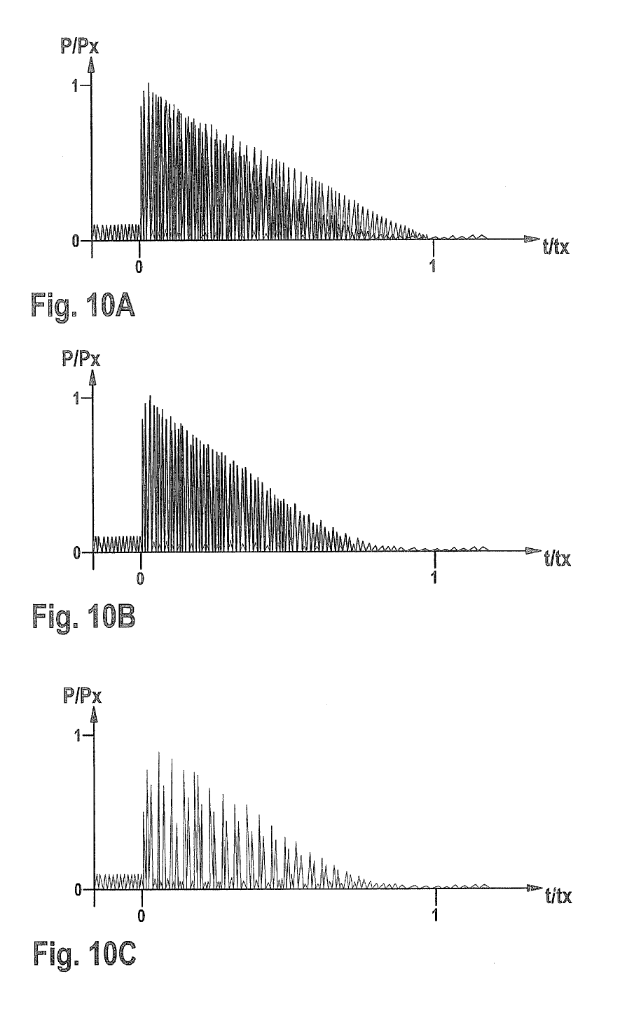

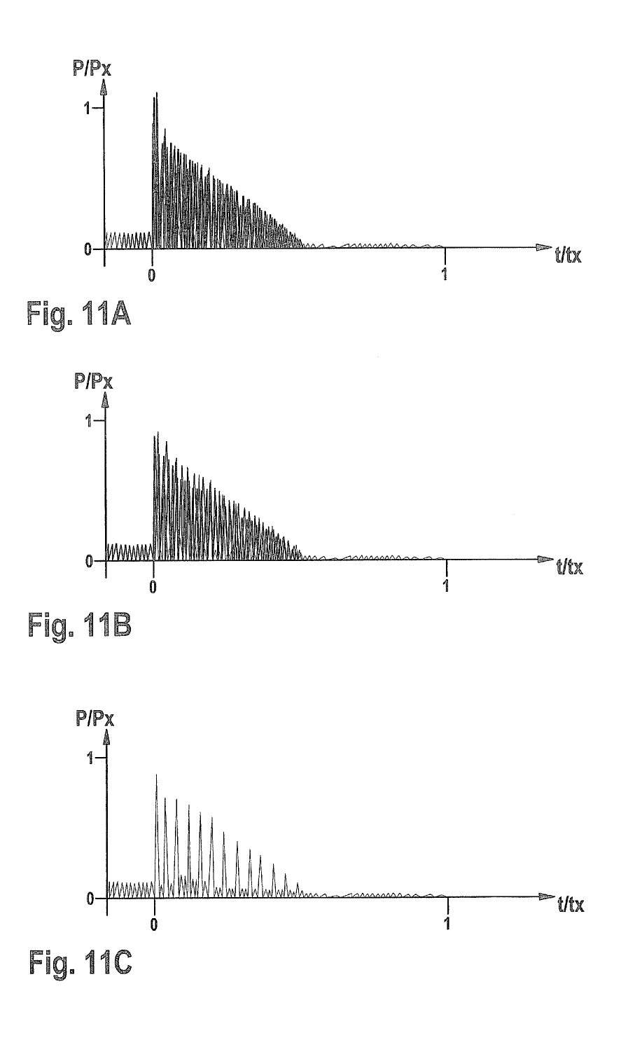

In FIG. 9, the response of a system and the associated power loss according to the related art upon occurrence of a load dump event are indicated. FIG. 10 corresponds to a system activated according to the diagram of FIG. 7A with an intervention into one rectifier arm, and FIG. 11 corresponds to a system activated according to the diagram of FIG. 8 with an intervention into both rectifier arms.

In each of partial FIGS. 9A, 10A and 11A, the power losses in the elements in the upper arm of the bridge rectifier are indicated; in partial FIGS. 9B, 10B and 11B, the power losses in the elements in the lower arm of the bridge rectifier are indicated; and in partial FIGS. 9C, 10C and 11C, the power loss of one single element in the lower arm is indicated.

In the graphs, t refers to the time period of the load dump in each case. P refers to the power losses in one or multiple elements without taking into account the switching element. A reduction of the power loss by factors of 3 through 4 when using the method according to the present invention could be ascertained by the simulations illustrated in FIGS. 9 through 11.

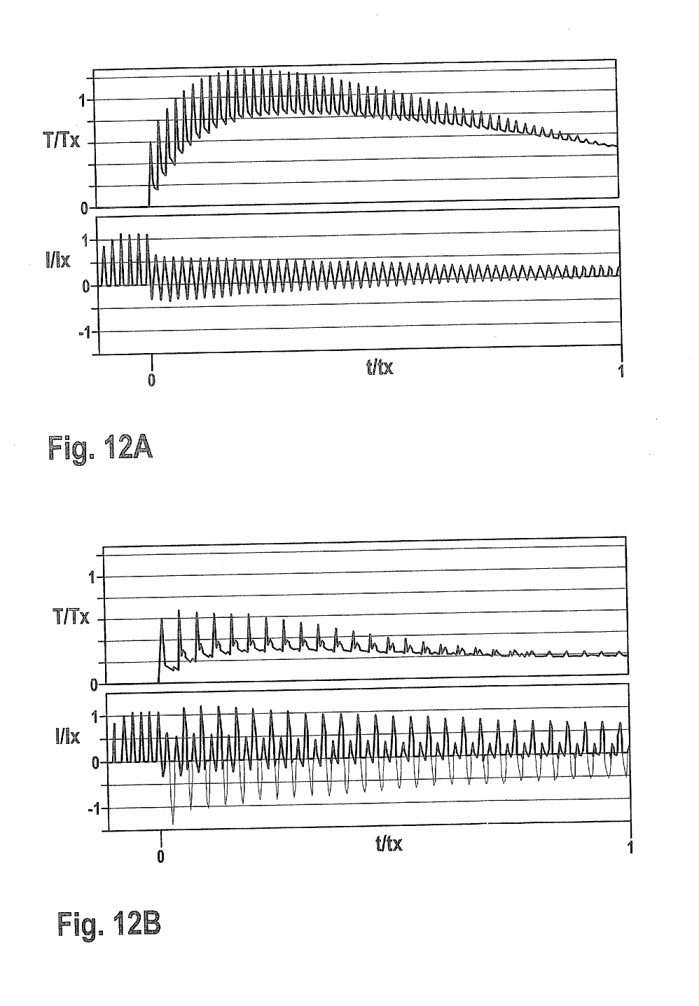

FIG. 12 shows temperature and current characteristics curves in switching elements of a three-phase bridge rectifier when activated according to the related art (FIG. 12 A) and when using a method according to the present invention according to the activation diagram (FIG. 12B) illustrated in FIG. 7B which was used with the three-phase current supplied by the generator. The field coil was entirely excited prior to the beginning of the load dump event, as is illustrated in the situation in FIGS. 9 through 11, and the generator was in the oscillated state. The time period of the load dump is identified by t; T indicates the temperature characteristics curve.

It is apparent from the figure that a significant temperature reduction could be achieved by the method according to the present invention. A reduction factor of 2 was demonstrated.

1-12. (canceled)

13. A method for reducing load dump overvoltages during operation of a synchronous rectifier for a polyphase alternating current, the rectifier having multiple inputs which correspond to the number of alternating current phases of the alternating current, and at least two outputs for providing a direct current, the method comprising:
connecting an alternating current phase to each of the respective inputs; and
electrically connecting each of the inputs via switching elements to one of the first output or the second output in accordance with a controller output;
wherein, upon determination of a load dump, an activation sequence is initiated, the activation sequence including:
(i) at least one of (a) connecting exactly one selected input to the second output for the time period of applying an entirely positive half-wave of an alternating current phase connected to the selected input, and (b) connecting exactly one selected input to the first output for the time period of applying an entirely negative half-wave of an alternating current phase connected to the selected input; and
(ii) each remaining input is connected to the first output when applying a positive half-wave of an alternating current phase connected to the selected input, and connected to the second output when applying a negative half-wave of an alternating current phase connected to the selected input.

14. The method as recited in claim 13, wherein one of a time control or an angular activation is used as an activation sequence.

15. The method as recited in claim 13, wherein the method is carried out in a rectifier of a generator of a motor vehicle.

16. The method as recited in claim 13, wherein the alternating current is a 3+n-phase alternating current, n being a non-negative integer.

17. The method as recited in claim 14, wherein a frequency of at least one alternating current phase is determined.

18. The method as recited in claim 17, wherein the frequency of at least one alternating current phase is used for the time control.

19. The method as recited in claim 13, wherein the electrically connecting each of the inputs via switching elements to one of the first output or the second output is carried out with the aid of one of MOSFET transistors or IGB transistors.

20. The method as recited in claim 13, wherein a load dump is determined on the basis of an output voltage between the outputs of the rectifier.

21. The method as recited in claim 13, wherein:
(i) in the presence of a first set of conditions, one of (a) exactly one selected input is connected to the second output for the time period of applying an entirely positive half-wave of an alternating current phase connected to the selected input, or (b) exactly one selected input is connected to the first output for the time period of applying an entirely negative half-wave of an alternating current phase connected to the selected input; and
(ii) in the presence of a second set of conditions, exactly one selected input is connected to the second output for the time period of applying an entirely positive half-wave of an alternating current phase connected to the selected input, and exactly one input is connected to the first output for the time period of applying an entirely negative half-wave of an alternating current phase connected to the selected input.

22. The method as recited in claim 21, wherein the first and the second sets of conditions are different dimensions of load dumps.

23. The method as recited in claim 21, wherein activation times of the activation sequence are increased by a factor ≧3, the factor being calculated according to formula 3+2×n, with n being a non-negative integer.

24. A system for reducing load dump overvoltages during operation of a synchronous rectifier for a polyphase alternating current, the rectifier having multiple inputs which correspond to the number of alternating current phases of the alternating current, and at least two outputs for providing a direct current, an alternating current phase being connected to each of the respective inputs, comprising:
a control unit configured to initiate, upon determination of a load dump, an activation sequence with the aid of switching elements, the activation sequence including:
(i) at least one of (a) connecting exactly one selected input to the second output for the time period of applying an entirely positive half-wave of an alternating current phase connected to the selected input, and (b) connecting exactly one selected input to the first output for the time period of applying an entirely negative half-wave of an alternating current phase connected to the selected input; and
(ii) each remaining input is connected to the first output when applying a positive half-wave of an alternating current phase connected to the selected input, and connected to the second output when applying a negative half-wave of an alternating current phase connected to the selected input.
